(19) United States
(12) Patent Application Publication
(10) Pub. No.: US 2010/0265252 A1
(43) Pub. Date: Oct. 21, 2010

(54) RENDERING USING MULTIPLE INTENSITY REDISTRIBUTION FUNCTIONS

(75) Inventors: Helko Lehmann, Aachen (DE); Juergen Weese, Aachen (DE); Dieter Geller, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/808,398

(22) PCT Filed: Dec. 16, 2008
(86) PCT No.: PCT/IB08/55326

§ 371 Date: Jun. 16, 2010

(30) Foreign Application Priority Data
Dec. 20, 2007 (EP) 07123817.4

(51) Int. Cl. G06T 17/00

(52) U.S. Cl. 345/424

(57) ABSTRACT

The invention relates to a system (100) for visualizing an image data set comprising a plurality of voxels, using a ray casting method, each voxel of the plurality of voxels belonging to at least one class, each class of the at least one class being associated with an intensity redistribution function for computing a redefined voxel value of a voxel from a measured voxel value of said voxel, the system comprising a sampling unit (120) for computing a sample value at a sample location on a projection ray cast from an image pixel, based on a redefined voxel value of at least one voxel proximal to the sample location on the projection ray, wherein the redefined voxel value of the at least one voxel is computed from a measured voxel value of the at least one voxel, using the intensity redistribution function associated with the at least one class of the at least one voxel.

### FIELD OF THE INVENTION

The invention relates to the field of volume image data visualization and more particularly to the field of visualizing multiple objects comprised in an image data volume, using ray casting.

### BACKGROUND OF THE INVENTION

Ray-casting image rendering methods such as, e.g., maximum intensity projection (MIP), digitally reconstructed radiographs (DRR) or direct volume rendering (DVR), are often used for visualizing CT or MRI volumetric images. Often, there are multiple objects comprised in a segmented image data volume. Some of the objects, e.g. ribs, may obstruct the view of another object, e.g., the heart.

An article by I. Viola, A. Kanitsar and M. E. Groeller, “Importance-driven volume rendering”, IEEE Visualization 2004 Oct. 10-15, Austin, Tex., USA, pages 139-145, hereinafter referred to as Ref 1, describes a method of visualizing objects in segmented image data. This method employs a modified DVR, where the importance of objects described in image data is defined by an importance index. In an image computed from the image data, objects having a higher importance index are arranged so as to be more visible than objects having a lower importance index. This is achieved by associating different levels of sparseness with different importance indexes and by using importance compositing. In DVR, a transfer function assigns a color and opacity to each sample within the volume of volumetric data. Sample values along each ray cast from the image plane into the image data volume are composited and a final image is computed. The sparseness of objects is defined by the opacity assigned to object samples. Samples of important objects are opaque while samples of less important objects are semi or fully transparent. The ways of defining levels of sparsity described in Ref. 1 include opacity and/or color modulation, screen door transparency, and volume thinning.

### SUMMARY OF THE INVENTION

The present invention provides a new, very intuitive and easy-to-implement approach to visualizing multiple objects comprised in an image data volume, using ray casting.

In an aspect of the invention, a system for visualizing an image data set comprising a plurality of voxels, using a ray casting method, is provided, each voxel of the plurality of voxels belonging to at least one class, each class of the at least one class being associated with an intensity redistribution function for computing a redefined voxel value of a voxel from a measured voxel value of said voxel, the system comprising a sampling unit for computing a sample value at a sample location on a projection ray cast from an image pixel, based on a redefined voxel value of at least one voxel proximal to the sample location on the projection ray, wherein the redefined voxel value of the at least one voxel is computed from a measured voxel value of the at least one voxel, using the intensity redistribution function associated with the at least one class of the at least one voxel.

For example, voxels of a first class, describing bones, may be assigned a first intensity redistribution function which results in low redefined gray values of the bones visualized in the image. On the other hand, voxels of a second class, describing blood vessels, may be assigned a second intensity redistribution function which results in high gray values of the blood vessels visualized in the image. The image may be computed using MIP, for example. Thus, a user examining the image may see the blood vessels while the bone structures are not visualized in the image. Advantageously, a region of interest to be visualized in the image may be defined by a tissue-type voxel classification or by other information, e.g., obtained from voxel classification based on image data segmentation. For example, the coronary arteries may have an intensity redistribution function different from an intensity redistribution function of the pulmonary veins.

A person skilled in the art will understand that voxel values represent voxel intensities. There are different scales and units for expressing voxel values including, but not limited to, Hounsfield units (HU) and gray values represented by integers from the range [0, 255]. The intensity redistribution function may be defined using any suitable voxel intensities.

In an embodiment of the system, the sampling unit comprises:
a location unit for selecting the sample location on the projection ray cast from the image pixel;
a voxel unit for selecting the at least one voxel proximal to the sample location;
a redefinition unit for computing the redefined voxel value of the at least one voxel from a measured voxel value of the at least one voxel, using the intensity redistribution function associated with the at least one class of the at least one voxel; and
a composition unit for computing the sample value at the sample location, based on the redefined voxel value of the at least one voxel on the projection ray.
   These units represent a useful implementation of the sampling unit.

In an embodiment, the system further comprises a redistribution unit for shaping the intensity redistribution function, based on a user input. The modified intensity redistribution function may be applied by the system to the image data and a new image may be computed in real time. The computed image may be displayed on a display. The user is thus enabled to interactively redefine the gray values of voxels of a class for optimal visualization of the viewed image data set.

In an embodiment of the system, the ray casting method is the maximum intensity projection or minimum intensity projection. The maximum or minimum intensity projection is a popular rendering technique and most radiologists know how to interpret images rendered using this rendering technique.

In an embodiment of the system, the at least one class comprises a background class. All voxels which cannot be classified as voxels of a structure or tissue may be classified as background class voxels.

In an embodiment of the system, the at least one class comprises a plurality of classes. This embodiment helps to deal with cases in which a voxel cannot be uniquely classified as a voxel of only one class. The sample value at a sample location on a projection ray cast from an image pixel is computed based on a plurality of redefined gray values of the voxel, wherein each redefined voxel value of the voxel is computed from a measured voxel value of the voxel, using a different intensity redistribution function associated with a different class of the voxel

In an embodiment, the system further comprises a classification unit for determining the at least one class of the at least one voxel. In an embodiment, the classification unit may employ a voxel classifier. In another embodiment, the classification unit may employ image data segmentation.

In a further aspect of the invention, a method of visualizing an image data set comprising a plurality of voxels, using a ray casting method, is provided, each voxel of the plurality of voxels belonging to at least one class, each class of the at least one class being associated with an intensity redistribution function for computing a redefined voxel value of a voxel from a measured voxel value of said voxel, the method comprising a sampling step for computing a sample value at a sample location on a projection ray cast from an image pixel, based on a redefined voxel value of at least one voxel proximal to the sample location on the projection ray, wherein the redefined voxel value of the at least one voxel is computed from a measured voxel value of the at least one voxel, using the intensity redistribution function associated with the at least one class of the at least one voxel.

In a further aspect of the invention, a computer program product to be loaded by a computer arrangement is provided, the computer program product comprising instructions for visualizing an image data set comprising a plurality of voxels, using a ray casting method, each voxel of the plurality of voxels belonging to at least one class, each class of the at least one class being associated with an intensity redistribution function for computing a redefined voxel value of a voxel from a measured voxel value of said voxel, the computer arrangement comprising a processing unit and a memory, the computer program product, after being loaded, providing said processing unit with the capability to carry out the task of computing a sample value at a sample location on a projection ray cast from an image pixel, based on a redefined voxel value of at least one voxel proximal to the sample location on the projection ray, wherein the redefined voxel value of the at least one voxel is computed from a measured voxel value of the at least one voxel, using the intensity redistribution function associated with the at least one class of the at least one voxel.

In a further aspect of the invention, the system according to the invention is comprised in an image acquisition apparatus.

In a further aspect of the invention, the system according to the invention is comprised in a workstation.

It will be appreciated by those skilled in the art that two or more of the above-mentioned embodiments, implementations, and/or aspects of the invention may be combined in any way deemed useful.

Modifications and variations of the image acquisition apparatus, of the workstation, of the method, and/or of the computer program product, which correspond to the described modifications and variations of the system, can be carried out by a person skilled in the art on the basis of the present description.

A person skilled in the art will appreciate that the method may be applied to multidimensional image data, e.g., to 3-dimensional or 4-dimensional images, acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM).

### BRIEF DESCRIPTION OF THE DRAWINGS

These and other aspects of the invention will become apparent from and will be elucidated with respect to the implementations and embodiments described hereinafter and with reference to the accompanying drawings, wherein:

FIG. 1 schematically shows a block diagram of an exemplary embodiment of the system;

FIG. 2 illustrates an exemplary intensity redistribution function associated with a class of voxels;

FIG. 3 illustrates visualizing the heart using MIP rendering applied to CT heart data according to the invention;

FIG. 4 illustrates visualizing the coronary arteries using MIP rendering applied to the above CT heart data according to the invention;

FIG. 5 shows a flowchart of an exemplary implementation of the method;

FIG. 6 schematically shows an exemplary embodiment of the image acquisition apparatus; and

FIG. 7 schematically shows an exemplary embodiment of the workstation.

Identical reference numerals are used to denote similar parts throughout the Figures.

### DETAILED DESCRIPTION OF EMBODIMENTS

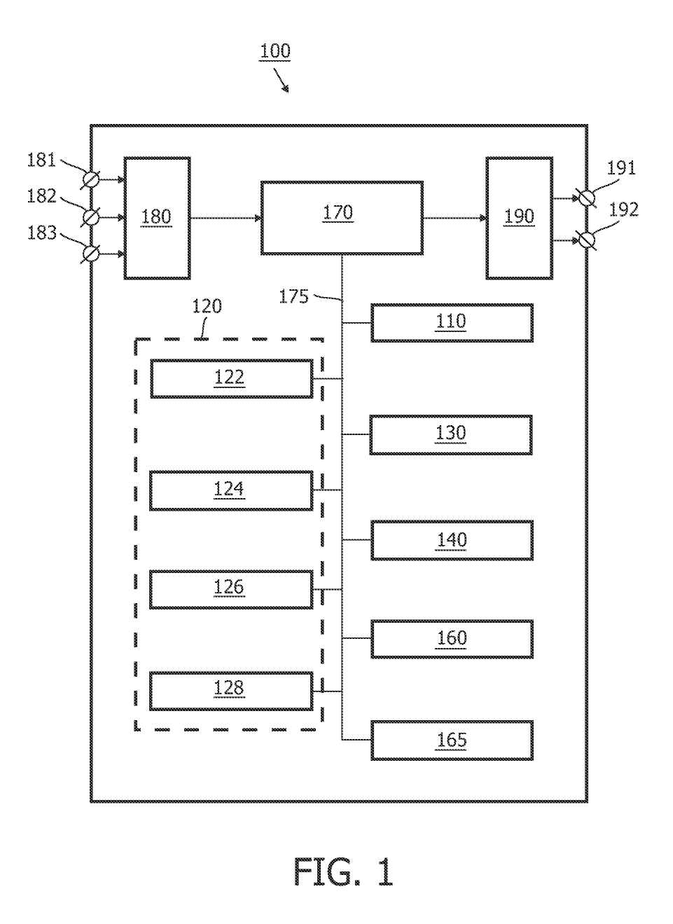

FIG. 1 schematically shows a block diagram of an exemplary embodiment of the system 100 for visualizing an image data set comprising a plurality of voxels, using a ray casting method, each voxel of the plurality of voxels belonging to at least one class, each class of the at least one class being associated with an intensity redistribution function for computing a redefined voxel value of a voxel from a measured voxel value of said voxel, the system comprising a sampling unit 120 for computing a sample value at a sample location on a projection ray cast from an image pixel, based on a redefined voxel value of at least one voxel proximal to the sample location on the projection ray, wherein the redefined voxel value of the at least one voxel is computed from a measured voxel value of the at least one voxel, using the intensity redistribution function associated with the at least one class of the at least one voxel.

The sampling unit 120 of the exemplary embodiment of the system 100 optionally comprises:
a location unit 122 for selecting the sample location on the projection ray cast from the image pixel;
a voxel unit 124 for selecting the at least one voxel proximal to the sample location;
a redefinition unit 126 for computing the redefined voxel value of the at least one voxel from a measured voxel value of the at least one voxel, using the intensity redistribution function associated with the at least one class of the at least one voxel; and
a composition unit 128 for computing the sample value at the sample location, based on the redefined voxel value of the at least one voxel on the projection ray.

The exemplary embodiment of the system 100 further comprises the following units:
a classification unit 110 for determining the at least one class of the at least one voxel;
a redistribution unit 130 for shaping the intensity redistribution function, based on a user input;
an image unit 140 for computing an image pixel value of an image pixel, based on the sample value at the sample location on the projection ray cast from said image pixel.
a control unit 160 for controlling the workflow in the system 100;
a user interface 165 for communicating with a user of the system 100; and
a memory unit 170 for storing data.

In an embodiment of the system 100, there are three input connectors 181, 182 and 183 for the incoming data. The first input connector 181 is arranged to receive data coming in from a data storage means such as, but not limited to, a hard disk, a magnetic tape, a flash memory, or an optical disk. The second input connector 182 is arranged to receive data coming in from a user input device such as, but not limited to, a mouse or a touch screen. The third input connector 183 is arranged to receive data coming in from a user input device such as a keyboard. The input connectors 181, 182 and 183 are connected to an input control unit 180.

In an embodiment of the system 100, there are two output connectors 191 and 192 for the outgoing data. The first output connector 191 is arranged to output the data to a data storage means such as a hard disk, a magnetic tape, a flash memory, or an optical disk. The second output connector 192 is arranged to output the data to a display device. The output connectors 191 and 192 receive the respective data via an output control unit 190.

A person skilled in the art will understand that there are many ways to connect input devices to the input connectors 181, 182 and 183 and the output devices to the output connectors 191 and 192 of the system 100. These ways comprise, but are not limited to, a wired and a wireless connection, a digital network such as, but not limited to, a Local Area Network (LAN) and a Wide Area Network (WAN), the Internet, a digital telephone network, and an analog telephone network.

In an embodiment of the system 100, the system 100 comprises a memory unit 170. The system 100 is arranged to receive input data from external devices via any of the input connectors 181, 182, and 183 and to store the received input data in the memory unit 170. Loading the input data into the memory unit 170 allows quick access to relevant data portions by the units of the system 100. The input data may comprise, for example, the image data set and intensity redistribution functions, one function for each class of a voxel classification scheme. The memory unit 170 may be implemented by devices such as, but not limited to, a Random Access Memory (RAM) chip, a Read Only Memory (ROM) chip, and/or a hard disk drive and a hard disk. The memory unit 170 may be further arranged to store the output data. The output data may comprise, for example, the image computed according to the invention. The memory unit 170 may be also arranged to receive data from and/or deliver data to the units of the system 100 comprising the classification unit 110, the contribution unit 120, the image unit 130, the control unit 160, and the user interface 165, via a memory bus 175. The memory unit 170 is further arranged to make the output data available to external devices via any of the output connectors 191 and 192. Storing data from the units of the system 100 in the memory unit 170 may advantageously improve performance of the units of the system 100 as well as the rate of transfer of the output data from the units of the system 100 to external devices.

Alternatively, the system 100 may comprise no memory unit 170 and no memory bus 175. The input data used by the system 100 may be supplied by at least one external device, such as an external memory or a processor, connected to the units of the system 100. Similarly, the output data produced by the system 100 may be supplied to at least one external device, such as an external memory or a processor, connected to the units of the system 100. The units of the system 100 may be arranged to receive the data from each other via internal connections or via a data bus.

In an embodiment of the system 100, the system 100 comprises a control unit 160 for controlling the workflow in the system 100. The control unit may be arranged to receive control data from and provide control data to the units of the system 100. For example, after computing the sample value at one sample location on a projection ray, the sampling unit 120 may be arranged to provide control data “the sample value computed” to the control unit 160 and the control unit 160 may be arranged to provide control data “determine the sample value at the next sample location on the projection ray” to the sampling unit 120. Determining the next location or the next projection ray may be carried out by the image unit 130, control unit 160 or sampling unit 120. A control function may be implemented in any unit of the system 100.

In an embodiment of the system 100, the system 100 comprises a user interface 165 for communicating with the user of the system 100. The user interface 165 may be arranged to receive a user definition of an intensity redistribution function. The user interface may further provide means for rotating the image data set to compute different views which are useful for specifying the path. The user interface may also provide the user with information, e.g., with a histogram of voxels belonging to a voxel class for displaying on a display. Optionally, the user interface may receive a user input for selecting a mode of operation of the system such as, e.g., for selecting an image rendering technique. A person skilled in the art will understand that more functions may be advantageously implemented in the user interface 165 of the system 100.

In an embodiment of the system 100, the input data comprises an image data set where each voxel comprises a voxel location, voxel value, i.e., voxel intensity, and voxel class. The sampling unit 120 is adapted to compute the redefined value of each voxel used for computing the sample value at a given location on a projection ray. The redefined voxel values are computed from the measured voxel values, using the intensity redistribution functions corresponding to the classes of a respective voxel. Next, the sampling unit 120 is adapted to compute the sample value at the given location on the projection ray, using the computed redefined voxel values. Different sampling techniques including, but not limited to, nearest neighbor, tri-linear, Gaussian, or cubic spline, may be used.

In an embodiment, the control unit 160 is arranged to determine the rays cast from pixels of the image and to determine sample locations on each ray. The distances between adjacent sample locations may be identical.

A voxel class may be defined based on a tissue type, such as, e.g., bone, blood, muscle, and/or on a structure represented by a voxel, such as, e.g., femur, ribs, lungs, heart. The intensity redistribution function may be predefined for each class and automatically applied by the system 100 to a processed voxel based on its class.

Depending on the assumptions underlying the data classification, a voxel may belong to several tissue classes at the same time. In an embodiment, the voxel value of a voxel corresponds to an accumulated density of several tissue types comprised in the voxel volume, and the voxel classification represents how much of the accumulated density belongs to which tissue type. A classification vector is defined for each voxel and each vector component represents how much of the voxel value belongs to the tissue type corresponding to the position of said component within the classification vector. Hence, it is possible to calculate the sum of the contributions of the different tissue types. The contribution of a particular tissue type to the measured voxel value is the product of the measured voxel value by the vector component corresponding to the particular tissue type. This measured contribution is used to compute the redefined contribution corresponding to the class of the particular tissue type, using the intensity redistribution function corresponding to the class of the particular tissue type.

In an embodiment of the system 100, the image data set comprises a plurality of voxels, where each voxel comprises voxel coordinates, a voxel value and a tissue type vector, each vector component describing a weight c^{t} of a tissue type t. For each tissue type t an intensity redistribution function fₜ is provided. Pixel intensities are computed using a standard ray casting procedure, i.e., for each pixel p in the image plane a ray is cast in the viewing direction and at each sample location i on the cast ray, a sample value sᵢ and a tissue type vector cᵢ=(cᵢ^{t}) is acquired from the voxel data, e.g., by nearest-neighbor or tri-linear interpolation of the neighboring voxels. Based on the sample value and tissue type vector, the contribution of each tissue type t at each sample location i can be written as:

wᵢ^{t}=sᵢ·cᵢ^{t}.

The weights cᵢ^{t}≧0 satisfy the condition:

$${\sum }_{t} {c}_{i}^{t} \leq 1.$$

Thereby the weight of intensity at the sample location i that is not classified is given by

$${c}_{i} = 1 - {\sum }_{t} {c}_{i}^{t} .$$

This weight cᵢ is referred to as a background class weight. The contribution of the background class to the sample value at each sample location i is:

wᵢ=s_{i·c}ᵢ.

The background class is assigned a background intensity redistribution function f. The sample value vᵢ at the sample location is given by:

$${v}_{i} = max ( {max}_{t} {f}_{t} ( {w}_{i} ) , f ( {w}_{i} ) ) .$$

Alternatively, the sample value vᵢ at the sample location may be defined as a sum of all contributions:

$${v}_{i} = {\sum }_{t} {f}_{t} ( {w}_{i}^{t} ) + f ( {w}_{i} ) .$$

In the maximum intensity projection, the pixel value vₚ is the maximum of all sampling values vᵢ on the ray cast from said pixel:

$${v}_{p} = {max}_{i} ( {v}_{i} ) ,$$

Alternatively, the pixel value may be computed as an average of all sampling values vᵢ on the ray cast from said pixel:

$${v}_{p} = \frac{1}{N} {\sum }_{i} {v}_{i} ,$$

where N denotes the number of samples.

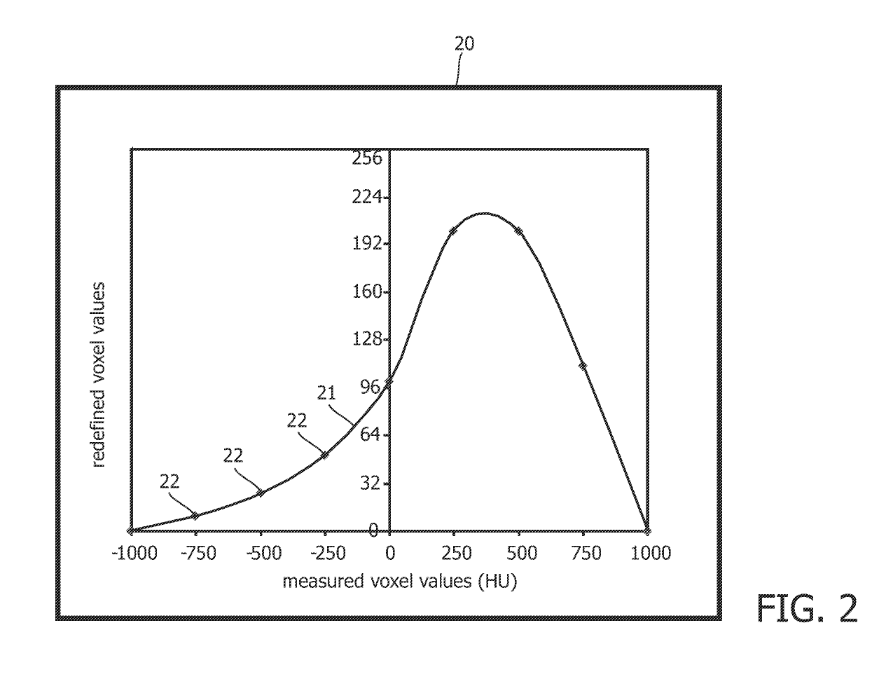

In an embodiment, the system 100 comprises a redistribution unit 130 for shaping the intensity redistribution function, based on a user input. FIG. 2 illustrates an exemplary intensity redistribution function associated with a class of voxels. In a window 20 for displaying on a display, the user may define the intensity redistribution function by drawing a graph 21 of the intensity redistribution function. The measured voxel values are expressed in Hounsfield units (HU). The redefined voxel values are expressed as grayscale values. The graph may be implemented as a polyline or a Bezier curve controlled by a number of control points 22 placed by the user, for example. Advantageously, the user-defined intensity redistribution function may be used in real time to compute an image for displaying on the display, e.g., in an image window. The user may interactively continue adjusting the intensity redistribution function, based on the feedback from the displayed image. Optionally, the window 20 may be arranged for displaying a histogram of voxel values of voxels of the class corresponding to the shaped intensity redistribution function. Optionally, the redistribution unit 130 may be included in the user interface 165.

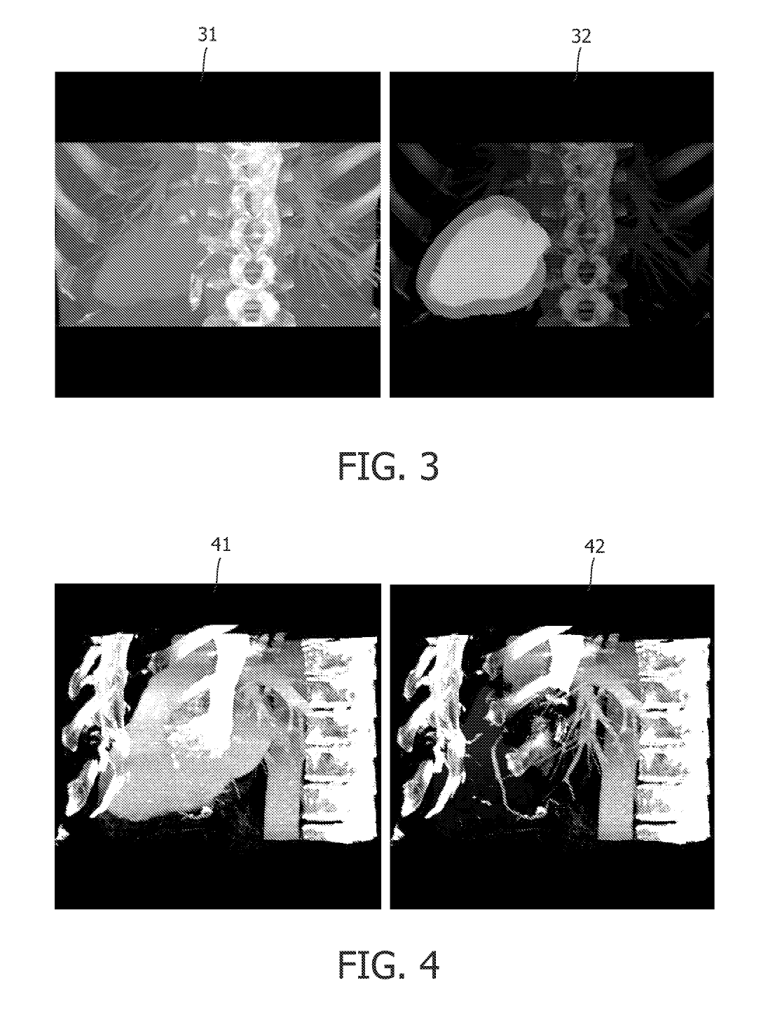

In an embodiment of the system 100, the image unit 140 of the system uses the maximum intensity projection (MIP) technique for image rendering. For each ray cast from a pixel in the image plane, the pixel value is the maximum sample value along this ray. FIG. 3 illustrates visualizing the heart using MIP technique applied to CT heart data, according to the invention. The image 31 on the left shows a standard MIP of a CT heart data set. The image 32 on the right shows the same view of the same data set where three different linear intensity redistribution functions are applied, two for highlighting the lumen of the left ventricle and the myocardium, respectively, and one to visualize some tissues providing reference structures that help to orient the image. FIG. 4 illustrates visualizing the coronary arteries using MIP rendering applied to the above CT heart data according to the invention. The image 41 on the left shows another standard MIP view of the above CT heart data set. The image 42 on the right shows the same view of the same data set where seven different regions, each region classifying a different tissue type, are suppressed by applying appropriate intensity redistribution functions. Hence, the image yields an unobstructed view of one of the coronary arteries, for which no segmentation data has been available.

A person skilled in the art will understand that any suitable technique, such as, but not limited to, a technique for generating a direct volume rendering, a closest vessel projection, or a digitally reconstructed radiogram, may be used to compute the pixel values.

A person skilled in the art will appreciate that the system 100 may be a valuable tool for assisting a physician in many aspects of her/his job.

Those skilled in the art will further understand that other embodiments of the system 100 are also possible. It is possible, among other things, to redefine the units of the system and to redistribute their functions. Although the described embodiments apply to medical images, other applications of the system, not related to medical applications, are also possible.

The units of the system 100 may be implemented using a processor. Normally, their functions are performed under the control of a software program product. During execution, the software program product is normally loaded into a memory, like a RAM, and executed from there. The program may be loaded from a background memory, such as a ROM, hard disk, or magnetic and/or optical storage, or may be loaded via a network like the Internet. Optionally, an application-specific integrated circuit may provide the described functionality.

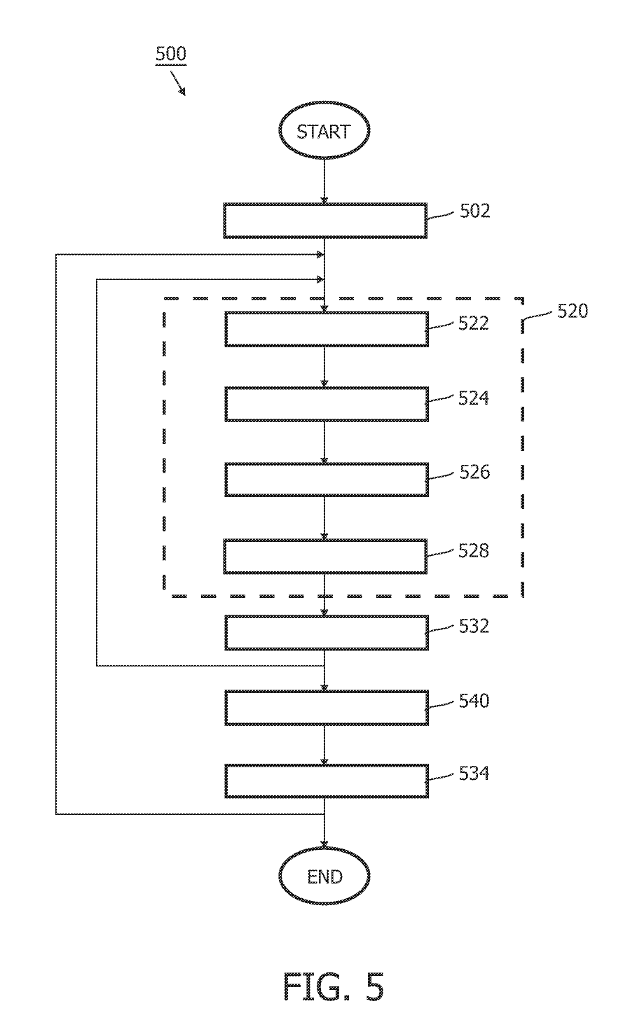

FIG. 5 shows a flowchart of an exemplary implementation of the method 500 of visualizing an image data set comprising a plurality of voxels, using a ray casting method. Each voxel of the plurality of voxels belongs to at least one class. Each class of the at least one class is associated with an intensity redistribution function for computing a redefined voxel value of a voxel from a measured voxel value of said voxel. The method begins with an initialization step 502 for determining the initial ray and the initial sample location based on the image data set. After the initialization step 502, the method continues to the sampling step 520 for computing a sample value at a sample location on a projection ray cast from an image pixel, based on a redefined voxel value of at least one voxel proximal to the sample location on the projection ray, wherein the redefined voxel value of the at least one voxel is computed from a measured voxel value of the at least one voxel, using the intensity redistribution function associated with the at least one class of the at least one voxel. This is carried out in a sequence of sub-steps. In a location step 522, the sample location is selected on the projection ray cast from the image pixel. In a voxel step 524, the at least one voxel proximal to the sample location is selected from the image data set. In a redefinition step 526, the redefined voxel value of the at least one voxel is computed from a measured voxel value of the at least one voxel, using the intensity redistribution function associated with the at least one class of the at least one voxel. In a composition step 528, the sample value at the sample location is computed based on the redefined voxel value of the at least one voxel on the projection ray. After the sampling step 520, the method continues to a location update step 532 for updating the sample location on the ray. After the location update step 532, the method 500 continues to the sampling step 520 or, if sample values at all sample locations on the ray have been computed, the method 500 continues to an image step 540 for computing an image pixel value of an image pixel, based on the sample value at the sample location on the projection ray cast from said image pixel. After the image step 540, the method 500 continues to a ray update step 534 for selecting a next pixel and a next ray cast from that pixel and an initial sample location on that ray. After the ray update step 534, the method continues to the sampling step 520 or, if pixel values of all pixels in the image plane have been computed, the method ends.

A person skilled in the art may change the order of some steps or perform some steps concurrently using threading models, multi-processor systems or multiple processes without departing from the concept as intended by the present invention. Optionally, two or more steps of the method of the current invention may be combined into one step. Optionally, a step of the method of the current invention may be split into a plurality of steps.

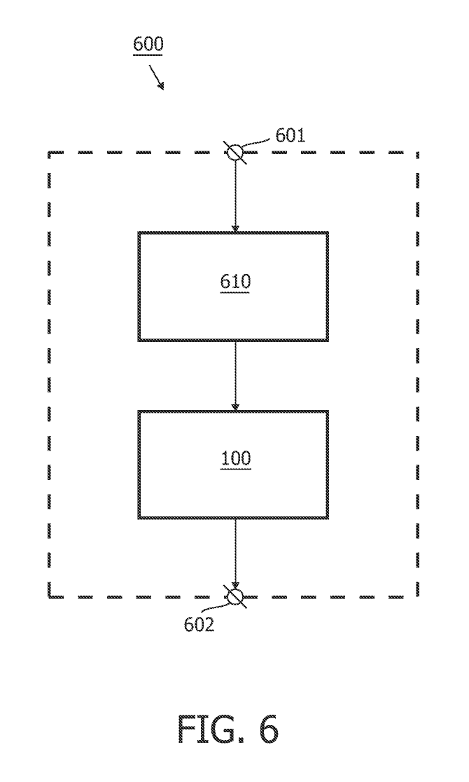

FIG. 6 schematically shows an exemplary embodiment of the image acquisition apparatus 600 employing the system 100, said image acquisition apparatus 600 comprising a CT image acquisition unit 610 connected via an internal connection with the system 100, an input connector 601, and an output connector 602. This arrangement advantageously increases the capabilities of the image acquisition apparatus 600, providing said image acquisition apparatus 600 with advantageous capabilities of the system 100.

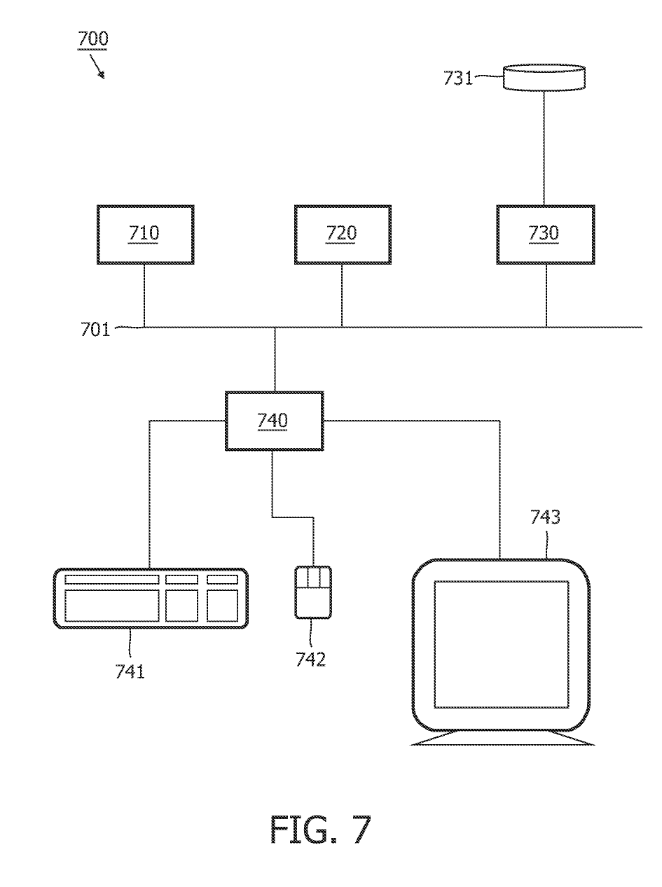

FIG. 7 schematically shows an exemplary embodiment of the workstation 700. The workstation comprises a system bus 701. A processor 710, a memory 720, a disk input/output (I/O) adapter 730, and a user interface (UI) 740 are operatively connected to the system bus 701. A disk storage device 731 is operatively coupled to the disk I/O adapter 730. A keyboard 741, a mouse 742, and a display 743 are operatively coupled to the UI 740. The system 100 of the invention, implemented as a computer program, is stored in the disk storage device 731. The workstation 700 is arranged to load the program and input data into memory 720 and execute the program on the processor 710. The user can input information to the workstation 700, using the keyboard 741 and/or the mouse 742. The workstation is arranged to output information to the display device 743 and/or to the disk 731. A person skilled in the art will understand that there are numerous other embodiments of the workstation 700 known in the art and that the present embodiment serves the purpose of illustrating the invention and must not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention can be implemented by means of hardware comprising several distinct elements and by means of a programmed computer. In the system claims enumerating several units, several of these units can be embodied by one and the same item of hardware or software. The usage of the words first, second, third, etc., does not indicate any ordering. These words are to be interpreted as names.

1. A system (100) for visualizing an image data set comprising a plurality of voxels, using a ray casting method, each voxel of the plurality of voxels belonging to at least one class, each class of the at least one class being associated with an intensity redistribution function for computing a redefined voxel value of a voxel from a measured voxel value of said voxel, the system comprising a sampling unit (120) for computing a sample value at a sample location on a projection ray cast from an image pixel, based on a redefined voxel value of at least one voxel proximal to the sample location on the projection ray, wherein the redefined voxel value of the at least one voxel is computed from a measured voxel value of the at least one voxel, using the intensity redistribution function associated with the at least one class of the at least one voxel.

2. A system (100) as claimed in claim 1, wherein the sampling unit (120) comprises:
a location unit (122) for selecting the sample location on the projection ray cast from the image pixel;
a voxel unit (124) for selecting the at least one voxel proximal to the sample location;
a redefinition unit (126) for computing the redefined voxel value of the at least one voxel from a measured voxel value of the at least one voxel, using the intensity redistribution function associated with the at least one class of the at least one voxel; and
a composition unit (128) for computing the sample value at the sample location, based on the redefined voxel value of the at least one voxel on the projection ray.

3. A system (100) as claimed in claim 1, further comprising a redistribution unit (130) for shaping the intensity redistribution function, based on a user input.

4. A system (100) as claimed in claim 1, wherein the ray casting method is the maximum intensity projection or minimum intensity projection.

5. A system (100) as claimed in claim 1, wherein the plurality of classes comprise a background class.

6. A system as claimed in claim 1, wherein the at least one class comprises a plurality of classes.

7. A method (500) of visualizing an image data set comprising a plurality of voxels, using a ray casting method, each voxel of the plurality of voxels belonging to at least one class, each class of the at least one class being associated with an intensity redistribution function for computing a redefined voxel value of a voxel from a measured voxel value of said voxel, the method comprising a sampling step (520) for computing a sample value at a sample location on a projection ray cast from an image pixel, based on a redefined voxel value of at least one voxel proximal to the sample location on the projection ray, wherein the redefined voxel value of the at least one voxel is computed from a measured voxel value of the at least one voxel, using the intensity redistribution function associated with the at least one class of the at least one voxel.

8. An image acquisition apparatus (600) comprising a system (100) as claimed in claim 1.

9. A workstation (700) comprising a system (100) as claimed in claim 1.

10. A computer program product to be loaded by a computer arrangement, comprising instructions for visualizing an image data set comprising a plurality of voxels, using a ray casting method, each voxel of the plurality of voxels belonging to at least one class, each class of the at least one class being associated with an intensity redistribution function for computing a redefined voxel value of a voxel from a measured voxel value of said voxel, the computer arrangement comprising a processing unit and a memory, the computer program product, after being loaded, providing said processing unit with the capability to carry out the task of computing a sample value at a sample location on a projection ray cast from an image pixel, based on a redefined voxel value of at least one voxel proximal to the sample location on the projection ray, wherein the redefined voxel value of the at least one voxel is computed from a measured voxel value of the at least one voxel, using the intensity redistribution function associated with the at least one class of the at least one voxel.
